(19) United States
(12) Patent Application Publication
(10) Pub. No.: US 2014/0215209 A1
(43) Pub. Date: Jul. 31, 2014

(54) ENTERPRISE DISTRIBUTED FREE SPACE FILE SYSTEM

(71) Applicant: Simy Chacko, Hyderabad (IN)

(72) Inventor: Simy Chacko, Hyderabad (IN)

(21) Appl. No.: 13/753,419

(22) Filed: Jan. 29, 2013

(51) Int. Cl. G06F 21/60

(52) U.S. Cl. CPC G06F 21/602
USPC 713/165

(57) ABSTRACT

A method and system for effective utilization of free space in electronic devices with a non-volatile memory, across an enterprise is disclosed. The enterprise distributed free space file system disclosed herein comprises a central server and multiple nodes with an agent in each node. The agent creates hidden blocks of configurable sizes in the free spaces of each electronic device and reports the availability of blocks to the central server. The central server encrypts the content to be stored in the blocks and generates an encryption key for each block. The encryption keys are randomly generated and stored in the database of the central server. The encrypted content is invisible to the owner of the electronic device. The encryption key is not shared with nodes or any other system. Further, the stored content in the free spaces can be accessed only through the central server.

The present application claims priority from Indian Application Number 4623/CHE/2012, filed on 5 Nov. 2012, the disclosure of which is hereby incorporated by reference herein.

### TECHNICAL FIELD

The embodiments herein relate to the field of data storage in computers and more particularly to a plurality of networked computers storing data on internal non-volatile memory devices.

### BACKGROUND

Recently, in electronic devices with a non-volatile memory space and so on, the data capacity has increased to levels at which many users have large volumes of spare non-volatile memory available, which exceeds their data storage requirements. For example, in a system of networked personal computers running on any operating system, communicating with the file server upon which data is stored, individual PCs may have unused non-volatile data storage capacities in the range of 50-950 gigabytes (Gbs). Further, the unused space in case of a tablet computer ranges form 3-64 (Gbs), whereas for a smart phone the unused volatile data storage capacity in the range of 2-32 (Gbs). This effectively represents a resource which has been paid for, but which remains unused. Whatever the size of computer network, having unused non-volatile disk space in a network adds to the cost of ownership of a network, but provides no benefit to the network owner.

Size of the non-volatile secondary storage space in a typical PC has increased from 3.75 megabytes to 4 terabytes or more in the recent years. Price has also decreased from about US$15,000 per megabyte to less than $0.0001 per megabyte. Further, according to a survey conducted recently on new PCs and Laptops in an enterprise, average hard drive capacity is 500 Gb to 2 Tb and only 20-30% are utilized at any point of time. For example, an enterprise that has 50000 PC, may have 35000 Tb free space, which is not being utilized. Further, the devices such as cell phone, tablet and so on also has non-volatile storage space from 1 Gb to 64 Gb and major portion of the storage space is not being utilized effectively.

For storing and managing data in the free space of electronic devices, a file system can be used. File systems are primarily concerned with the overall management of files in a computer system or in a network. Among other things, file systems generally contain methods for providing files to be stored, referenced, shared and secured. Further a file system provides methods for accessing data stored in files and maintains file integrity to ensure that the information in a file remains uncorrupted.

In the light of above discussion, there is a need for a method and system that converts the unused space of an electronic device to a general purpose secured and distributed file system that can be used for backup and archiving.

### BRIEF DESCRIPTION OF THE FIGURES

The embodiments herein will be better understood from the following detailed description with reference to the drawings, in which:

FIG. 1 illustrates a block diagram of the overall system, according to embodiments disclosed herein; and

FIG. 2 is a flow diagram explaining the various steps involved in an enterprise distributed free space file system, according to embodiments disclosed herein.

### DETAILED DESCRIPTION OF EMBODIMENTS

The embodiments herein and the various features and details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and a system for effective utilization of free space in electronic devices having a non-volatile memory, across an enterprise. The enterprise distributed free space file system disclosed herein is a dynamic and distributed file system which is created in the free space available in the personal computers (PCs) that are connected in a network. The content stored in the free space is invisible to the owner of the electronic device and is not readable (encrypted). The network with a plurality of nodes, where each node is connected to an electronic device is monitored by a central server. The enterprise distributed free space file system (EDFS-FS) disclosed herein comprises a central server and multiple nodes with an agent in each node. The agent creates hidden blocks of configurable sizes in the free spaces available in each electronic device and reports the availability of these blocks to the central server. The central server encrypts the content to be stored in the blocks and generates an encryption key for each block. The encryption keys are randomly generated and stored in the database of the central server. The encryption key is not shared with nodes or any other system. Further, the stored content in the blocks of free spaces can be accessed only through the central server. The central server copies the stored content to a new node which is available. In case there is any block that is unavailable for a given period of time.

In an embodiment, the method and system of free space file system disclosed herein can be applicable to an enterprise, data centers, other organizations like internet service providers (ISPs) and telecom service providers (TSPs). Further, the cloud service providers can create such file system using the devices or PCs that are under their control.

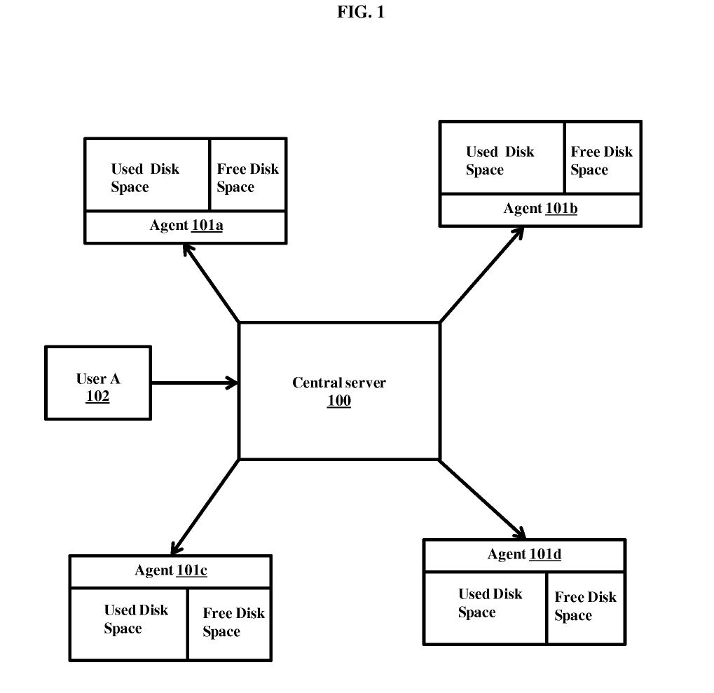

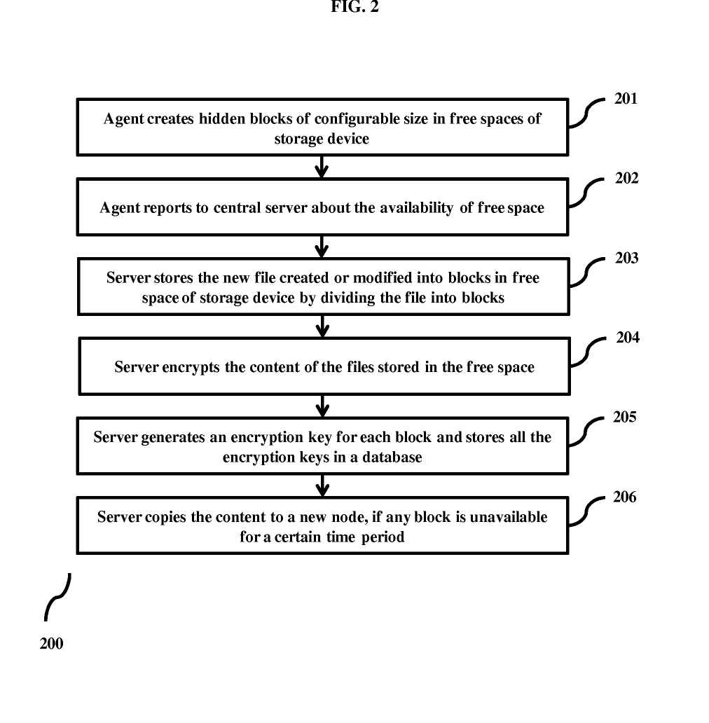

Referring now to the drawings, and more particularly to FIGS. 1 and 2, where similar reference characters denote corresponding features consistently throughout the figures, there are shown embodiments.

FIG. 1 illustrates a block diagram of the overall system, according to embodiments disclosed herein. As depicted in the figure, the enterprise distributed free space file system comprises a plurality of electronic devices with non-volatile memory space connected to a central server 100, an agent in each node connected to the central server 100. The agents in each node connected to the central server are shown in the figure as agent 101a, agent 101b, agent 101c and agent 101d. Further, a user 102 can access the stored content in the free space of the electronic devices using the central server 100. For the purpose of demonstration, only the electronic devices with non-volatile storage space that are connected to the central server 100 are shown. For example, the electronic device with memory space may be a PC with a hard disk, which is divided into used disk space and free disk space, as shown in the figure. Each electronic device with storage space (for example, a PC with a hard disk) is connected to the central server 100 through a node. In an embodiment, the agent can be software residing in the hard disk of the electronic device and each agent in the hard disk plays a similar role.

In an embodiment, the electronic device can be personal computer (PC), cell phone, tablet, Personal Digital Assistant (PDA), laptop, media players and any electronic gadget comprising a non-volatile memory space.

The agent present in each node creates hidden blocks of configurable sizes in the free space and reports the availability of blocks to the central server 100. For example, a block of size 1 Gb can be created by the agent and this availability of 1 Gb sized block is reported to the central server by the agent in each node. Further, the 1 Gb blocks created in the free space is a typical binary file in the base files system such as new technology file system (NTFS), yet another flash file system (YAFFS) or file allocation table (FAT) or third extended file system (EXT3). These files will be hidden to the users of the electronic device by using a file system filter driver which is part of a node agent.

The central server 100 detects the availability of hidden blocks through the agent. Further, the central server 100 tracks all the nodes attached to it and monitor each and every node. Every new file created or modified is encrypted by the central server 100 and is divided into the blocks of 1 Gb size (configurable). For example, consider a file of size 10 Gb needs to be stored in the free space of the electronic device. This file is divided into ten parts with each part holding 1 Gb of data by the central server 100. This 1 Gb parts are stored in the hidden blocks in the free space. Further, the file is stored in more than two configurable nodes (electronic devices) of the network. In other words, the content stored in each and every block will have a multiple replica. This is to ensure the effective recovery of the stored content in case of unavailability of any particular block over a period of time. The central server 100 monitors or tracks the unavailability of blocks stored in nodes. Incase if there is any block which is unavailable for more than a given period of time (say 24 hours), the central server 100 copies the stored content to a new node which is available in the network.

This stored content in the free space is invisible to the owner of the electronic device. The central server 100 generates an encryption key for each block randomly and stores all the encryption keys in a database. In an embodiment, the database that stores all the encryption keys of the hidden blocks in the free spaces may reside in the central server 100. The data transferred to the nodes are encrypted and the encryption key is never shared with the nodes or any other system that supports any block encryption algorithm that is in use today. In an embodiment, there can exist any number of nodes to the central server 100, where a plurality of electronic devices are interconnected to each other to form a network across an enterprise.

The user 102 can access the stored content (files) in the hidden blocks only though the central server 100. The central server 100 provides access to the stored content through any of the protocols such as hyper text transfer protocol (HTTP), file transfer protocol (FTP), network file system (NFS), common internet file system (CIFS) and so on.

The content is stored in the free (unused file system area) space in the desktops. The owner of the electronic device will be able to view and can use his free space, anytime whenever he wants. This will be handled using a file system filter driver. In an embodiment, the actual content is hidden in the free space areas of the electronic device that are owned by an organization or an enterprise.

FIG. 2 is a flow diagram explaining the various steps involved in an enterprise distributed free space file system, according to embodiments disclosed herein. The method and system for creating an enterprise distributed free space file system (EDFS-FS) is as described herein. Initially an agent in each node connected to the central server 100, creates (201) hidden blocks of configurable sizes in the free space of the electronic devices. In an embodiment, the agent in each node creates blocks of 1 Gb size (which can be configurable according to the storage requirements) in the available free spaces of the electronic devices in the network. The network comprises a plurality of electronic devices having non-volatile memory space are interconnected to each other and is monitored by a central server 100. Further, the agent, after creating the hidden blocks of configurable sizes in the free spaces, reports (202) the availability of free space in the hidden blocks to the central server 100. The central server 100 stores (203) the new file that is created or modified into the blocks in the free space of the electronic device by dividing the new file into blocks of configurable sizes. Further, the central server 100 encrypts (204) the content that is stored in the hidden blocks of the free space.

Every new file that is created or modified is encrypted by the central server 100 and is divided into the blocks of 1 Gb size (configurable). Further, the file is stored in more than two configurable nodes by the central server 100. In other words, the content stored in each and every block will have a multiple replica in the other nodes that are available. This is to ensure the effective recovery of the stored content in case of unavailability of any particular block over a period of time.

The central server 100 generates (205) a different encryption key for the content stored in each block in the free space and stores in a database. In an embodiment, the database that stores all the encryption keys of the hidden blocks in the free spaces may reside in the central server 100. The data transferred to the nodes are encrypted and the encrypted keys are not shared with the nodes or any other system that supports block encryption algorithm that is in use today. Further, the central server monitors all the nodes that are connected to it.

Further, if the central server 100 detects the unavailability of a block with a stored content in any of the nodes in the network, the central server 100 copies (206) the stored content to a new node (electronic device) which is available. In an embodiment, the if the central server 100 detects any block unavailable for more than 24 hours (configurable), the central server 100 copies the content to another electronic device that is available in the network. In this way the encrypted content that is stored in the hidden blocks of the free space in the electronic s device will be copied and stored in multiple nodes of a network, thereby enabling the backup of the data every time. Even when one electronic device on the network is not functioning (e.g. PC is not operating over a given time), the encrypted content in the blocks can be accessed using any other node in that network through the central server 100. Hence effective backup and archiving of data can be achieved using the method and system of enterprise distributed free space file system. There can be a scenario, where the total free space available in a node is more than the storage requirement. In such scenarios, the administrator of the network should be able to add more disk space by adding new nodes anytime.

By using the method and system of enterprise distributed free space file system as described above, the organizations or enterprises can create huge volumes of storage space with near dollar investment. Further, by using this method, a maximum utilization of free space in an electronic device or an instrument can be achieved. The method can achieve inherent disaster recovery, if the nodes in the disclosed method are distributed into multiple geo locations. Further, this method reduces the processing overhead in node PCs.

The disclosed method of enterprise distributed free space file system can create huge storage volumes when it is implemented in cloud based devices or PC management systems. Further, the method assumes good network connectivity among the nodes for achieving better performance.

The embodiments disclosed herein can be implemented through at least one software program running on at least one hardware device and performing network management functions to control the elements. The elements shown in FIGS. 1 include blocks which can be at least one of a hardware device, or a combination of hardware device and software module.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for maximum utilization of free space in electronic devices with non-volatile memory connected in a network, wherein said method comprises:
creating blocks in said free space of at least one electronic device, wherein said at least one electronic device is connected to a server;
storing at least one encrypted content in said blocks in said free space by said server, wherein said encrypted content stored in said free space of said electronic device is invisible to owner of said electronic device;
accessing said encrypted content stored in said blocks using said server; and
copying said encrypted content to a new electronic device connected in said network, if said block is unavailable.

2. The method as in claim 1, wherein said method creates said blocks of configurable sizes in said free spaces of said electronic device using an agent associated with said electronic device.

3. The method as in claim 1, wherein said content is divided into said blocks of said configurable sizes, before storing said content in said free spaces of said at least one electronic device in said network.

4. The method as in claim 3, wherein said content in said blocks is encrypted by said server, before storing said content in said free space, and said server generates different encryption keys for said blocks.

5. The method as in claim 1, wherein said encrypted content is copied to said new electronic device in said network, if said block with said encrypted content is unavailable for a certain time period, wherein said time period is configurable.

6. A system for maximum utilization of free space in electronic devices with non-volatile memory, connected in a network, wherein said system comprises:
a central server;
an electronic device;
an agent;
wherein said agent is associated with said electronic device, further said system is configured to:
create blocks in said free space of at least one electronic device, wherein said at least one electronic device is connected to a server;
store at least one encrypted content in said blocks in said free space by said server, wherein said encrypted content stored in said free space of said electronic device is invisible to owner of said electronic device;
access said encrypted content stored in said blocks using said server; and
copy said encrypted content to a new electronic device connected in said network, if said block is unavailable.

7. The system as in claim 6, wherein said agent is configured to create said blocks of configurable sizes, further said agent is configured to report the availability of said blocks to said server.

8. The system as in claim 6, wherein said server is configured to encrypt said content in said blocks, before storing said encrypted content in said free spaces of said at least one electronic device in said network.

9. The system as in claim 6, wherein said server is configured to generate different encryption keys for said blocks.

10. The system as in claim 6, wherein said is server is configured to copy said encrypted content to said new electronic device in said network, if said block with said encrypted content is unavailable for a certain time period, wherein said time period is configurable.
